(19) United States
(12) Patent Application Publication
(10) Pub. No.: US 2026/0269329 A1
(43) Pub. Date: Sep. 10, 2026

(54) LIQUID LEAKAGE DETECTOR AND BATTERY SYSTEM INCLUDING THE SAME

(71) Applicant: Samsung SDI Co., Ltd., Yongin-si (KR)

(72) Inventors: Ilya GOMBATS, Graz (AT); Katrin JAMMERNEGG, Graz (AT); Carina FRANK, Graz (AT)

(21) Appl. No.: 19/427,852

(22) Filed: Dec. 19, 2025

(30) Foreign Application Priority Data
Mar. 10, 2025 (EP) 25162676.8

(51) Int. Cl. H01M 10/42; G01M 3/18; H01M 10/48

(52) U.S. Cl. CPC H01M 10/4228; G01M 3/186; H01M 10/482

(57) ABSTRACT

A liquid leakage detector for detecting liquid in a battery system includes a flexible flat cable (FFC) including: a first electrical conductor and a second electrical conductor extending parallel to each other; an insulating layer partially enclosing at least one of the first electrical conductor and the second electrical conductor, the insulating layer having openings exposing the first and second electrical conductors; an electrical resistor at a first end portion of the FFC and electrically connected with the first electrical conductor and the second electrical conductor; and a detector electrically connected to the first electrical conductor and the second electrical conductor at a second end portion of the FFC opposite to the first end portion. The detector is configured to detect liquid by identifying an electrical current flowing via the liquid between the first exposed portion and the second exposed portion.

### CROSS-REFERENCE TO RELATED APPLICATION

The present application claims priority to and the benefit of European Patent Application No. 25162676.8, filed on March 10, 2025, in the European Intellectual Property Office, the entire disclosure of which is incorporated herein by reference.

### BACKGROUND

### Field

Embodiments of the present disclosure relate to a liquid leakage detector and a battery system including the same.

### Description of the Related Art

A battery system may include a battery management system (BMS), which is an electronic system that is configured to manage a rechargeable battery cell, a battery module, and/or a battery pack, such as by protecting the battery cells from operating outside their safe operating area, monitoring their states, calculating secondary data, reporting that data, controlling its environment, authenticating it, and/or balancing it. For example, the BMS may monitor the state of the battery cell as represented by voltage (e.g., a total voltage of the battery pack or battery modules and/or voltages of individual battery cells), temperature (e.g., an average temperature of the battery pack or battery modules, coolant intake temperature, coolant output temperature, or temperatures of individual battery cells), coolant flow (e.g., flow rate and/or coolant liquid pressure), and current.

The battery system may include an active or passive thermal management system to provide thermal control of the battery pack and to allow safe use of the battery module by efficiently emitting, discharging, and/or dissipating heat generated from its rechargeable batteries. If the heat emission/discharge/dissipation is not sufficiently performed, temperature deviations may occur between respective battery cells, such that the battery module may no longer generate a desired (or designed) amount of power. In addition, an increase in the internal temperature can lead to abnormal reactions occurring therein, which causes charging and discharging performance of the rechargeable battery to deteriorate and the life-span of the rechargeable battery to be shortened.

The interface to a cooling system is complex because a cooling apparatus is often in direct contact with electrical components of the battery cell. In the case of battery cells having a relatively low height and sufficiently thick cell walls, it may be sufficient that the cooling system simply makes contact with a bottom of the battery cells via a cooling plate. Should this prove inadequate, supplementary heat conduction elements may be incorporated between the battery cells to facilitate the transfer of heat to the cooling plate. The use of fluid-conducting cooling plates between battery cells has been demonstrated to be effective because the heat conduction path from the interior of the battery cell to the cooling fluid is relatively short, resulting in a high degree of temperature homogeneity within the battery cell.

An alternative approach to cooling is arrester cooling in which interior of the battery cell is cooled directly via electrodes. For example, pouch battery cells are well-suited for this type of cooling, as they have flat and, therefore, relatively easy-to-contact electrodes. The waste heat from the battery cells is directed into a cooling plate. There, either cooling water or an evaporating refrigerant absorbs the heat and dissipates it to the environment via the vehicle's cooling (or refrigeration) system.

Supplying the battery system with a coolant liquid, such as water, introduces a risk of a coolant liquid leak from the cooling channels or coolant interfaces in the battery system (e.g., in a battery pack or even within a battery module). Therefore, leakage events should be rapidly detected to prevent damage to the battery system and to components in the battery system.

Liquid leakage detectors are often included in the battery system to detect liquid leaks, such as coolant liquid leaks from a coolant manifold and/or coolant interfaces. Conventionally, cables having open connectors at end portions are used as liquid leakage detectors. Such liquid leakage detectors include a resistor in parallel to the open ends to detect a liquid (e.g., water) that connects (e.g., electrically connects) the open ends, thereby forming a parallel liquid resistor, causing a reduction in the overall resistance, which can be detected by current/resistance processing.

However, the installation of the liquid leakage detectors in the battery system is cumbersome in terms installation and in terms of reserving sufficient space for the detector and the harness in the housing.

It is also difficult to provide reasonable detection thresholds to discriminate between humidity (e.g., condensed water or condensation) and an actual liquid leakage event where liquid has escaped from the cooling manifold.

The above information is only described for better understanding of the present disclosure and is not intended to limit the present disclosure as described below.

### SUMMARY

The present disclosure is defined by the appended claims and their equivalents. The description that follows is subject to this limitation. Any disclosure lying outside the scope of the claims and their equivalents is intended for illustrative as well as comparative purposes.

According to an embodiment of the present disclosure, a liquid leakage detector for detecting liquid in a battery system includes a flexible flat cable (FFC). The FFC includes a first electrical conductor and a second electrical conductor extending parallel to each other and an insulating layer at least partially enclosing the first and/or the second electrical conductor. The liquid leakage detector further includes an electrical resistor located at a first end portion of the FFC and electrically connected with the first electrical conductor and the second electrical conductor at the first end portion. Further, the insulating layer has a first opening forming a first exposed portion of the first electrical conductor and a second opening forming a second exposed portion of the second electrical conductor. Moreover, the liquid leakage detector includes a detector electrically connected to the first electrical conductor and the second electrical conductor at a second end portion of the FFC opposite to the first end portion. The detection unit is configured to detect liquid based on identifying an electrical current flowing via a liquid between the first exposed portion and the second exposed portion.

According to another embodiment of the present disclosure, a battery system includes a plurality of battery cells accommodated in a housing and the above-described liquid leakage detector in the housing.

Further embodiments, aspects, and features of the present disclosure can be learned from the dependent claims and the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic view of a liquid leakage detector according to an embodiment;

FIG. 2 is a cross-sectional view of a flexible flat cable taken along the line A-A in FIG. 1 according to an embodiment;

FIG. 3 is a cross-sectional view of a flexible flat cable taken along the line A-A in FIG. 1 according to another embodiment;

FIG. 4 is a cross-sectional view of a flexible flat cable taken along the line A-A in FIG. 1 according to another embodiment;

FIG. 5 is a cross-sectional view of a flexible flat cable taken along the line A-A in FIG. 1 according to another embodiment;

FIG. 6 is a cross-sectional view of a flexible flat cable taken along the line A-A in FIG. 1 according to another embodiment;

FIG. 7 isa schematic view of a liquid leakage detector according to another embodiment;

FIG. 8 isa schematic view of a liquid leakage detector according to another embodiment; and

FIG. 9 isa schematic view of a battery system according to an embodiment.

### DETAILED DESCRIPTION

Reference will now be made, in detail, to embodiments, examples of which are illustrated in the accompanying drawings. Aspects and features of the present disclosure, and implementation methods thereof, will be described with reference to the accompanying drawings. The present disclosure, however, may be embodied in various different forms and should not be construed as being limited to the embodiments illustrated herein. Rather, these embodiments are provided as examples so that the present disclosure will be thorough and complete and will fully convey the aspect and features of the present disclosure to those skilled in the art.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. For example, the expression "at least one of a, b, or c" indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly. Herein, the terms “upper” and "lower" are defined according to the z-axis. For example, an upper cover is positioned at the upper part in the z-axis, and the lower cover is positioned at the lower part in the z-axis.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. Further, the various components of these devices may be implemented on a flexible printed circuit film, a tape carrier package (TCP), a printed circuit board (PCB), or formed on one substrate. The electrical connections or interconnections described herein may be realized by wires or conducting elements, e.g., on a PCB or another kind of circuit carrier. The conducting elements may include metallization, e.g. surface metallizations and/or pins, and/or may include conductive polymers or ceramics. Further electrical energy might be transmitted via wireless connections, e.g. using electromagnetic radiation and/or light.

Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like.

Also, a person of skill in the art should recognize that the functionality of various computing devices may be combined or integrated into a single computing device, or the functionality of a particular computing device may be distributed across one or more other computing devices without departing from the scope of the exemplary embodiments of the present disclosure.

According to an embodiment of the present disclosure, a liquid leakage detector for detecting leaked liquid in a battery system is provided. The liquid leakage detector includes a flexible flat cable (FFC). The FFC includes a first electrical conductor and a second electrical conductor extending parallel to each other. The FFC further includes an insulating layer at least partially enclosing the first and/or the second electrical conductor. The liquid leakage detector further includes an electrical resistor located at a first end portion of the FFC and electrically connected with the first electrical conductor and the second electrical conductor at the first end portion. Further, the liquid leakage detector has a first opening in the insulating layer forming a first exposed portion of the first electrical conductor through the insulating layer and a second opening in the insulating layer forming a second exposed portion in the second electrical conductor through the insulating layer. Moreover, the liquid leakage detector includes a detection unit (e.g., a detector) electrically connected to the first electrical conductor and the second electrical conductor at a second end portion of the FFC opposite to the first end portion. The detection unit is configured to detect liquid based on identifying an electrical current between the first exposed portion and the second exposed portion via the liquid.

The FFC may be a cable that is flat and flexible (e.g., has flexible characteristics). The FFC may include multiple flat conductors (e.g., at least two electrical conductors). The insulating layer may be a flexible plastic coating. The electrical resistor may be coupled/connected, for example, by soldering to the first end portion. The first/second end portions may also be referred to as first/second ends. In an event of liquid leakage, such as water leakage or a water-containing liquid leakage used as, for example, coolant, the leaked liquid covers and connects (e.g., electrically connects) the exposed portions of the electrical conductors to form an electrical resistor (e.g., a liquid resistor) parallel to the electrical resistor interconnected between the first and second connectors at the first end of the FFC. Thus, by applying a voltage to the resistors, an electrical current also flows between the exposed portions so that total resistance is reduced. This can be detected, for example, by determining a resistance drop (e.g., current increase) of the parallel resistors in response to applying a voltage to the resistors. The detection unit may include processing units (e.g., processors, such as a microprocessor) to determine resistance or to determine current (e.g., current sensing) to detect electrical current in response to a voltage (e.g., a predefined voltage). Further details of the detection unit and the liquid detection methods are known from liquid detection sensors. The resistance value of the electric resistor may be a similar value as the resistance value of the liquid connection (e.g., the liquid resistor) between the exposed portions to increase sensitivity, for example, obtain significant resistance drop for resistance/current measurements. In some embodiments, the FFC can be relatively long, such as 1 meter, 2 meters, or more.

Accordingly, a liquid leakage detector is provided using an FFC having exposed portions therein to detect leaked liquid in a battery system. Due to the reduced thickness and the flexibility of the FFC, the liquid leakage detector including the FFC is easy to install in the battery system compared to prior art solutions, and the FFC allows for simple integration and installation while requiring less space. In addition, the FFC is robust against bending during the installation, thereby simplifying the installation process.

According to an embodiment, a cross section of the FFC and/or the first and second electrical conductors is rectangular and has a width and a height, with the height being shorter than the width. this cross section configuration ensures that the FFC is relatively thin and requires less vertical space, which improves and eases an integration of the liquid leakage detector in a housing of the battery system.

According to an embodiment, the first opening and the second opening are formed on a same side of the FFC. The same side may be an upper side of the FFC. In such embodiments, the exposed portions have a same height position. Thus, the exposed portions are likely to be covered by the leaked liquid by the same leakage event. As well, when located in the upper portion, a threshold height with respect to a bottom surface may be defined or ensured by the upper position. Thus, a certain amount of liquid is needed to establish a liquid connection (e.g., to establish the liquid resistor) between the exposed portions.

According to an embodiment, a water-soluble coating covers the first exposed portion and the second exposed portion. A water-soluble coating is a layer including a material that is dissolved by water or a water-based liquid when such liquid or water-containing liquid contacts the water-soluble coating. Normal humidity may not dissolve the water-soluble coating, that is, may not be sufficient to dissolve the water-soluble coating, while an amount (e.g., a sufficient amount) of leaked coolant liquid may dissolve the water-soluble coating to allow the exposed portions to be electrically connected through the leaked liquid. Therefore, false leakage detection may be avoided by use of the water-soluble coating when, for example, only small amounts of liquids are present due to, for example, liquid condensation or humidity. In other words, a detection threshold is established that avoids false detection caused by normal humidity and normal condensed water or for very minor leakage cases. The water-soluble coating may also protect the exposed portions. The coolant liquid may refer to water or water-based liquid.

According to an embodiment, the water-soluble coating includes a polyvinyl alcohol (PVA) tape. The PVA tape is a water-soluble thermoplastic that can be easily attached on the conductors as a film or as a coating. For example, the PVA tape can be easily applied to the openings, for example, to the exposed portions. The PVA tape is very robust against humidity and, thus, safely prevents false detection of normal humidity conditions or small amounts of liquid leakage.

According to an embodiment, an ion releasing material is provided at or in the openings. The ion releasing material is configured to release ions to (or into) the liquid when dissolved by the liquid. The ion releasing material may release ions when in contact with leaked coolant liquid, such as water or water-containing liquids. Because the released ions increase the electrical conductivity of the liquid, the resistance of the liquid connection (e.g., of the liquid resistor) is reduced. This, for example, allows use of an electrical resister with a lower resistance value at the first end of the FFC. The ion releasing material may improve detection rapidity. The ion releasing material may be provided in a local environment of (e.g., around or near) the openings or therein.

According to an embodiment, the ion releasing material is disposed between the water-soluble coating and the respectively exposed portions. Thus, when or once the water-soluble coating is dissolved, the ions in the ion releasing material are released to the liquid. This ensures that the resistance of the liquid resistor is only reduced when the water-soluble coating is dissolved and not before. Thus, the prevention of false leakage due to the water-soluble coating is maintained while the ion releasing material improves detection rapidity.

According to an embodiment, the ion releasing material includes a salt material. A salt material or salt ions may, for example, be sodium chloride (NaCl) or potassium chloride (KCl). Thus, the ions may be salt ions that are released into the liquid to reduce the resistivity.

According to an embodiment, the ion releasing material is a coating and/or a powder. Thus, the ion releasing material may be easily applied to the electrical conductor.

According to an embodiment, the ion releasing material is included in the water-soluble coating. In such embodiments, when the water-soluble coating is dissolved, the ions are directly released in the same dissolving process. This results in an even faster response for detecting leaked liquid. Therefore, faster detection of leaked liquid may be achieved.

According to an embodiment, a corrosion protection layer is directly disposed on the respective exposed portions of the first and second electrical conductors. Therefore, in such embodiments, corrosion of the exposed portions can be prevented. Thus, metals for the conductors with short oxidations times (e.g., metals susceptible to oxidation) can be used. For example, aluminum may be used as the metal material of the electrical conductors.

According to an embodiment, the corrosion protection layer is a coating including at least one of gold, tin, and/or nickel. These materials have excellent corrosion protection. Therefore, corrosion can be more effectively prevented.

According to an embodiment, the first and second electrical conductors each includes a plurality of openings along the length (e.g., the cable direction) of the FFC respectively providing a plurality of pairs of exposed portions. Thus, due to the displacement, it can be assumed that normal humidity or very small amounts leaked liquid cannot establish a conductive connection between the exposed portions due to the increased distance. For example, it may not be sufficient to form an electrical connection in such case of small liquid amounts, while a larger amount of leaked coolant liquid may be able to electrically connect the displaced exposed portions. Thus, false leakage detection may be avoided by the displacement position. In other words, a threshold is provided avoiding false detection caused by normal humidity, normal condensed water, and or minor leakage amount.

According to an embodiment, the first and second electrical conductors each includes a plurality of openings along the cable direction, thereby providing a plurality of pairs of exposed portions. Therefore, a plurality of sensing locations can be provided with a single resistor and a single FFC. Therefore, the amount of wiring and resistors can be drastically reduced while still being capable of detecting liquid leakage at various positions in the battery system. No further addition of multiple detectors is required. For example, while in the prior art, the amount of wiring scales (or increases) with the number of sensing locations, according to embodiments of the present disclosure, only one FFC and one resistor is required to detect liquid at different locations.

According to an embodiment, the resistor has a resistance value in a range between about 100kΩ and about 300kΩ. Thus, the resistance value and the amount of resistance can be reduced compared to prior art solutions.

According to another embodiment of the present disclosure, a battery system includes a plurality of battery cells accommodated within a housing and the above-described liquid leakage detector within the housing.

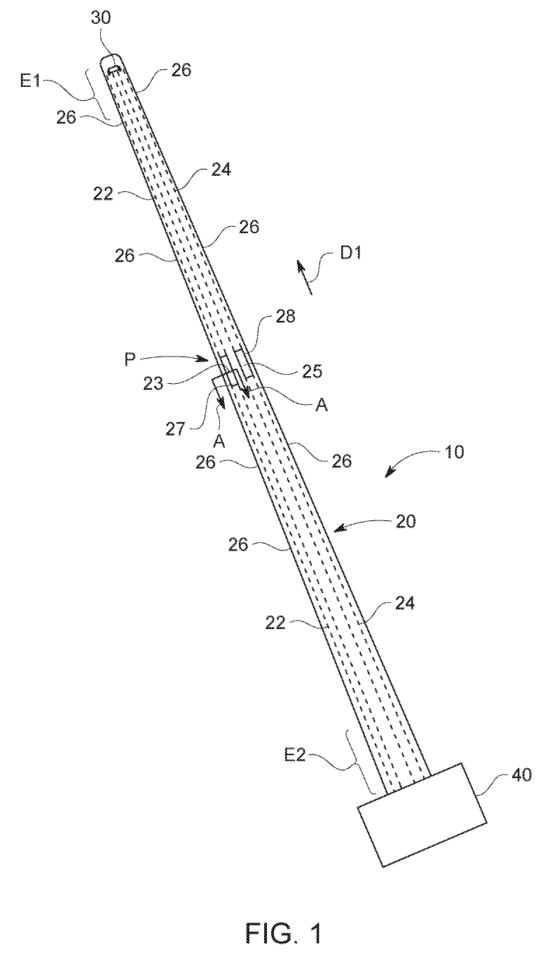

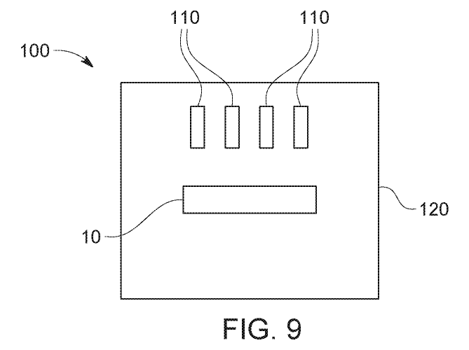

FIG. 1 is a schematic view of a liquid leakage detector 10 for detecting leaked liquid in a battery system 100 (see, e.g., FIG. 9) according to an embodiment of the present disclosure. According to embodiments of the present disclosure, a flexible flat cable (FFC) 20 is used to provide (e.g., forms) the liquid leakage detector 10.

The liquid leakage detector 10 includes the flexible flat cable (FFC) 20. The FFC 20 includes a first electrical conductor 22 and a second electrical conductor 24. The electrical conductors 22, 24 are indicated as dashed lines in FIG. 1. The first electrical conductor 22 and the second electrical conductor 24 extend parallel to each other. For example, a relative distance between the first electrical conductor 22 and the second electrical conductor 24 may be constant and may be predetermined. In other embodiments, the FFC 20 may include more than two electrical conductors.

The liquid leakage detector 10 further includes an insulating layer 26, such as an insulating coating like a plastic coating. The insulating layer 26 encloses or at least partially encloses the first and the second electrical conductors 22, 24. Thus, the first and the second electrical conductors 22, 24 may be insulated from the environment by the insulating layer 26. The FFC 20 may extend in a straight direction. Thus, for example, a cable direction D1 may be straight direction. However, because the FFC 20 is flexible, the FFC 20 may include bent portions (e.g., the FFC 20 may be bent to have bent or curved portions). Thus, the cable direction D1 may not be straight but may include curved portions. For example, the FFC 20 may be locally bent at edges in a housing 120 (see, e.g., FIG. 9) or locally bent for circumventing battery units or battery subunits in the battery system 100 in the housing 120. Thus, the FFC 20 can be suitably integrated and arranged in the housing 120.

An electrical resistor 30 is located at a first end portion (e.g., a first end or a distal end) E1 of the FFC 20. The electrical resistor 30 is electrically connected with the first electrical conductor 22 and the second electrical conductor 24 at the first end portion E1. For example, the electrical resistor 30 interconnects the electrical conductors 22, 24 with each other. Therefore, in response to an applied electrical voltage, an electrical current flows through the electrical resistor 30 between the first electrical conductor 22 and the second electrical conductor 24 according to the resistance value R of the electrical resistor 30. The electrical resistor 30 may have a resistance value R in a range between about 100kΩ and about 300kΩ, for example, between about 100kΩ and about 250kΩ, and in one embodiment, between about 100kΩ and about 200kΩ.

The liquid leakage detector 10 has a first opening 27 in the insulating layer 26. The first opening 27 exposes the first electrical conductor 22 with respect to (or through) the insulating layer 26. The first opening 27 may be a cut-out in the insulating layer 26. Thereby, a first exposed portion 23 of the first electrical conductor 22 is provided with respect to (e.g., through) the insulating layer 26. Further, the liquid leakage detector 10 includes a corresponding second opening 28 in the insulating layer 26. The second opening 28 exposes the second electrical conductor 24 with respect to the insulating layer 26. The second opening 28 may be a cut-out in the insulating layer 26. Thereby, a second exposed portion 25 of the second electrical conductor 24 is provided with respect to (e.g., through) the insulating layer 26. The first exposed portion 23 and the second exposed portion 25 may form a pair of exposed portions P.

When liquid in the battery system 100, such as a coolant (e.g., water or a water-based liquid), leaks to an amount (or extent) such that the exposed portions 23, 25 of the first electrical conductor 22 and the second electrical conductor 24 are connected with each other, an electrical connection is formed between the exposed portions 23, 25 by the leaked liquid allowing a flow of electrical current.

Therefore, in such a case, an electrical current flows between the exposed portions 23, 25 (e.g., between the pair P of exposed portions 23, 25) so that the liquid connection forms a liquid resistor R_{liq} that is parallel with the electrical resistor 30. Thus, a voltage applied to such resistor circuit allows a current flowing through the liquid resistor and the electrical resistor 30 according to the resistor value R of the electrical resistor 30 and the resistor value R_{liq} between the exposed portions 23, 25 through the leaked liquid medium. When there is no leaked liquid, no electrical current may flow between the exposed portions 23, 25 and an electrical current flow only through the electrical resistor 30, causing a relatively high resistance.

The liquid leakage detector 10 includes a detection unit (e.g., a detector) 40. The detection unit 40 is electrically connected to the first electrical conductor 22 and the second electrical conductor 24 at a second end portion E2 (e.g., a second end or a proximal end) of the FFC 20 opposite to the first end portion E1. The detection unit 40 detects liquid by identifying an electrical current flowing between the pair P of exposed portions 23, 25 through the leaked liquid as an electrically conductive medium. For example, a resistance drop or a current increase, for example, with respect to thresholds, may be identified thereby detecting leaked liquid (e.g., a resistor value of the resistor circuit drops).

Therefore, as described above, by using the FFC 20, a cost-efficient and flexible length liquid leakage detector 10 is provided which can detect liquid in the battery system 100 in an easy and practical manner. Because the FFC 20 has reduced thickness and high flexibility, the liquid leakage detector 10 can be easily installed in a complex environment of the battery system 100, thereby increasing convenience for integration and during installation while requiring less space.

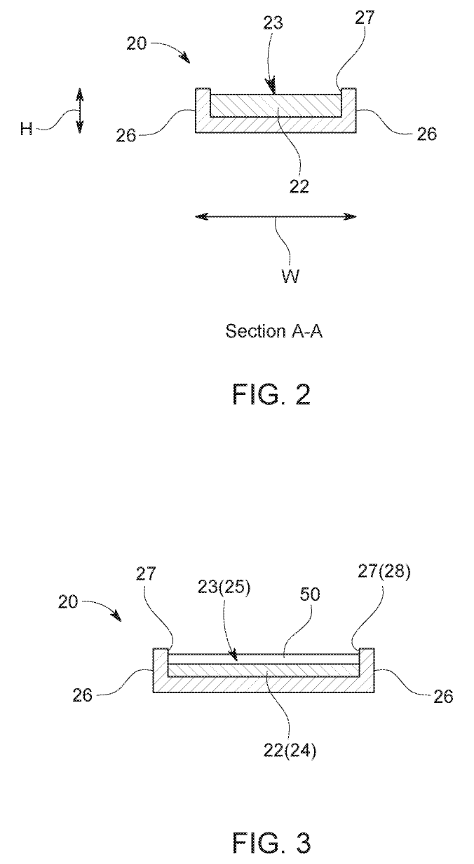

A cross-sectional view of the FFC 20 taken along the line A-A in FIG. 1 is shown in FIG. 2 according to an embodiment of the present disclosure.

For example, as shown in the example of FIG. 2, the FFC 20 may have a rectangular cross-section. The cross-section may have a width W and a height H, and the height H may be shorter than the width W. Therefore, the liquid leakage detector 10 can be compactly integrated, for example, in a housing 120 of a battery system 100 while being compact in height. Also, the FFC 20 may have rounded edges.

As shown in FIG. 1, the first opening 27 and the second opening 28 are formed (e.g. provided) on a same side of the FFC 20. As shown in FIG. 1, the first opening 27 and the second opening 28 are formed on an upper side of the first and second electrical conductors 22, 24. Thus, both openings 27, 28 are at a same height position. This allows for an equal height level for detecting the leaked liquid and defines a lower height threshold for detecting liquid, thereby avoiding a false detection of minor amounts of leaked liquid. In the present embodiment, the first opening 27 and the second opening 28 (e.g., the first and second exposed portions 23, 25) are adjacent to each other, but the present disclosure is not limited thereto as will be described below.

Referring to FIG. 3, a cross-sectional view of the FFC 20 taken along the line A-A in FIG. 1 is shown in accordance with another embodiment. Only the differences with respect to the embodiment shown in FIG. 2 are provided.

In this embodiment, the FFC 20 includes a water-soluble coating 50 (e.g., a water-soluble layer). The water-soluble coating 50 covers the exposed portions 23, 25 of the electrical conductors 22, 24. For example, the respective openings 27, 28 are covered by the water-soluble coating 50. Because leaked liquid requires a certain amount (e.g., threshold amount) of liquid (e.g., a coolant like water or liquids that are hydrophilic and include water) to dissolve the water-soluble coating 50, small amounts of, for example, condensed water, may not dissolve the water-soluble coating 50, thereby preventing exposure of the conductors 22, 24 at the openings 27, 28 due to the water-soluble coating 50. This makes the liquid leakage detector 10 more robust, thereby avoiding false positive detections based on minor amounts of liquid due to, for example, humidity. The liquid leakage detector 10 may, thus, discriminate a positive liquid leakage event from a case of mere water condensation or minor leakage, thereby increasing the detection robustness. The water-soluble coating 50 may be an electrically insulating material.

In an example, the water-soluble coating 50 is a polyvinyl alcohol (PVA) tape. This can be easily attached to the electrical conductors 22, 24 and provides a good moisture barrier. In an embodiment, the water-soluble coating 50 may be coated on the electrical conductors 22, 24 in the manufacturing process of the FFC 20, for example, by attaching water-soluble coating 50 as a tape (e.g., as a double-sided tape).

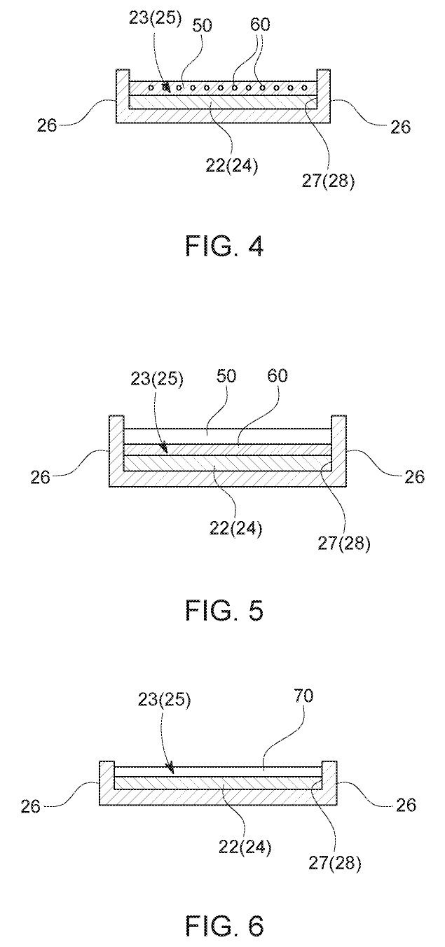

Referring to FIG. 4, a cross-sectional view of the FFC 20 taken along the line A-A in FIG. 1 is shown in accordance with yet another embodiment. Only the differences with respect to the embodiment shown in FIG. 3 are provided.

In this embodiment, an ion releasing material 60 is provided at (or in or over) the openings 27, 28. The ion releasing material 60 releases ions (e.g., salt ions, such as NaCl or KCl) into the leaked liquid when the ion releasing material is dissolved by the leaked liquid. Thus, when the water-soluble coating 50 is dissolved, the electrical resistance between the exposed openings 27, 28 is reduced due to the ions released into the liquid, thereby increasing electrical conductivity (e.g., reducing electrical resistance). This may allow a reduction of the resistance value of the electrical resistor 30.

In this embodiment, the ion releasing material 60 may be included (e.g., integrated) in the water-soluble coating 50. Thus, during the process of dissolving the water-soluble coating 50, the electrical resistance between the exposed portions 23, 25 is reduced due to the ions released from the water-soluble coating 50 at the same time. This may increase rapidity of leakage detection. In addition, robust detection is maintained because the electrical resistance is reduced by the dissolved ions between the exposed portions 23, 25 only when the water-soluble coating 50 is dissolved.

Referring to FIG. 5, a cross-sectional view of the FFC 20 taken along the line A-A in FIG. 1 is shown in accordance with yet another embodiment. Only the differences with respect to the embodiment shown in FIG. 4 are explained.

In this embodiment, an ion releasing material 60 is provided in the exposed portions 23, 25 of the electrical conductors 22, 24. The ion releasing material 60 releases ions to the liquid when dissolved by the liquid. Thus, when the water-soluble coating 50 is dissolved, the electrical resistance between the exposed openings 27, 28 is reduced (e.g., electrical conductivity increased) due to the released ions.

In this embodiment, the ion releasing material 60 is disposed between the water-soluble coating 50 and the respective conductor 22, 24. In other words, the ion releasing material 60 is below or under the water-soluble coating 50. Thus, the ion releasing material 60 is separately provided with respect to the water-soluble coating 50. When the water-soluble coating 50 is dissolved, the electrical resistance between the exposed openings 27, 28 is reduced due to release of ions from the ion releasing material 60. Because the ion releasing material 60 is separately provided, the dissolving properties of the water-soluble coating 50 may not be affected and a more conventional water-soluble coating 50 can be used, which simplifies manufacturing.

In an embodiment, the ion releasing material 60 includes a salt material. For example, the ion releasing material 60 may include (or may be) sodium chloride (NaCl) or potassium chloride (KCl). For example, the ion releasing material 60 may be provided as a coating or a powder.

Referring to FIG. 6, a cross-sectional view of the FFC 20 taken along the line A-A in FIG. 1 is shown in accordance with yet another embodiment. Only the differences with respect to the embodiments shown in FIG. 2 are described. The embodiment shown in FIG. 6 can be combined with the embodiments described above with respect to FIGS. 3 to 5.

In this embodiment, a corrosion protection layer 70 is disposed directly on the respective electrical conductors 22, 24. The corrosion protection layer 70 may be provided at the first and second exposed portions 23, 25 (e.g., at the openings 27, 28). For example, the corrosion protection layer 70 is a coating including at least one of gold, tin, and/or nickel, which may improve corrosion protection. When the corrosion protection layer 70 is provided, oxidation of the exposed portions 23, 25 of the electrical conductors 22, 24 is prevented or at least significantly reduced. Therefore, even materials with rapid oxidation rates when, for example, exposed to air may be used. For example, in an embodiment, copper and aluminum may be used as material for the electrical conductors 22, 24.

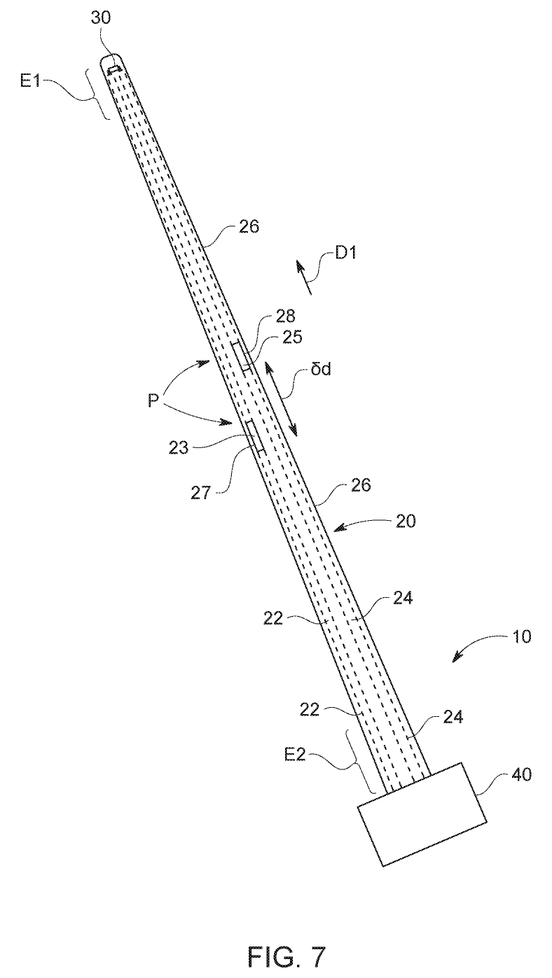

FIG. 7 is a schematic view of a liquid leakage detector 10 according to another embodiment. In this embodiment, only the differences with respect to the embodiment shown in FIG. 1 are described. The present embodiment can be combined with the embodiments described above with respect to FIGS. 2 to 6.

In this embodiment, the first and second openings 27, 28 (e.g., the exposed portions 23, 25) are spaced apart from each other by a displacement difference δd in cable direction D1. For example, one of the first and second openings 27, 28 (e.g., the exposed portions 25 ns 23, 25) forming the pair P of exposed portions 23, 25 is shifted in location with respect to one other one by the displacement difference δd in the cable direction D1.

In this embodiment, the first and second openings 27, 28 (e.g., the exposed portions 23, 25) are not directly adjacent to each other (e.g., not directly adjacent to each other in a direction perpendicular to the cable direction D1) but are displaced (or spaced) from each other along (or in) cable direction D1. This avoids false positive detections based on only minor amounts of liquid due to, for example, humidity and condensed water. For example, due to the displacement difference δd, a condensed liquid or a small amount of liquid may not fully connect the exposed portions 23, 25. Thus, the liquid leakage detector 10 has increased detection robustness for detecting leakage events by discriminating from mere humidity, condensed water, or minor leakage.

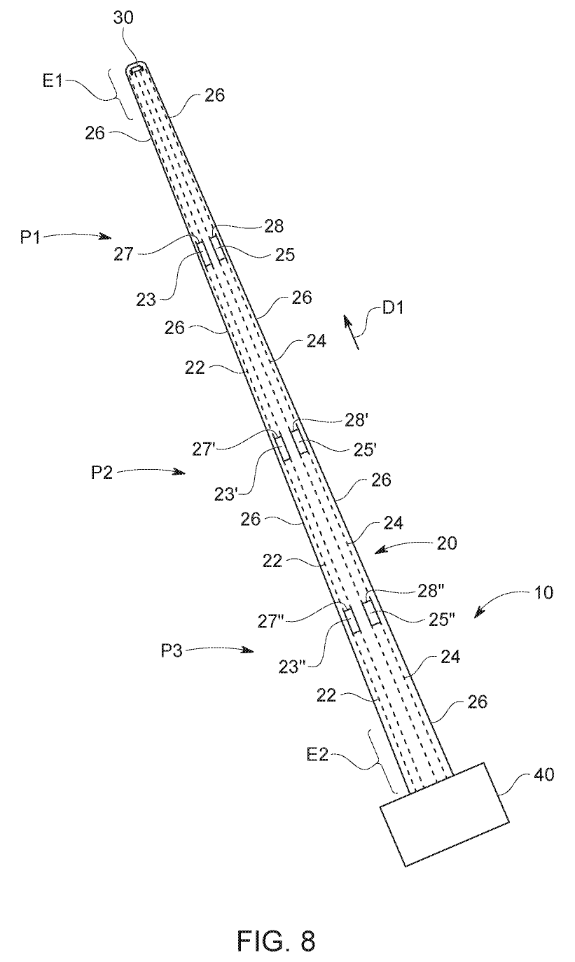

FIG. 8 is a schematic view of the liquid leakage detector 10 according to another embodiment. Only the differences with respect to the embodiment shown in FIG. 1 are described. The present embodiment can be combined with the embodiments described above with respect to FIGS. 2 to 7.

In this embodiment, the liquid leakage detector 10 includes a plurality of openings 27, 28; 27’, 28’; 27’’, 28’’ (e.g., equally first and second exposed portions 23, 25; 23’, 25’; 23’’, 25’’). Pairs of the plurality of openings 27, 28; 27’, 28’; 27’’, 28’’ (e.g., equally first and second exposed portions 23, 25; 23’, 25’; 23’’, 25’’) are provided along (or are spaced along) the cable direction D1. Therefore, a plurality of respective pairs, P1, P2, P3 of exposed portions 23, 25; 23’, 25’; 23’’, 25’’ is provide at different locations. The openings of the respective pairs P1, P2, P2 may be provided as shown in FIG. 1 (and as shown in FIG. 8) without displacement or as shown in FIG. 7 with a displacement difference δd. The pairs of insulator-exposing openings P1, P2, P3 may be spaced along the cable direction D1, respectively. Each of the pairs P1, P2, P3 refers to a location at where liquid leakage sensing is performed. For example, a first pair P1 may be electrically connected by a liquid while the other pairs P2, P3 may not be electrically connected. Thus, with only one FFC 20 and one electrical resistor 30, multiple different locations can be monitored (or sensed) for leaked liquid.

Therefore, only one electrical resistor 30 and one FFC 20 has multiple measurement points (e.g., multiple pairs P1, P2, P3) that allow for detection of liquid at various positions, thereby drastically reducing installation effort, material requirements, and material costs. For example, in the related art, the number of sensing locations may scale with the number of electrical resistors and harnesses while, according to embodiments of the present disclosure, only one resistor or FFC 20 allows for multiple sensing locations.

FIG. 9 shows schematically a battery system 100 according to an embodiment. The battery system 100 includes a plurality of battery cells 110. The battery cells 110 are accommodated within a housing 120. The battery cells 110 may be arranged in an order. A liquid leakage detector 10 according to one or more of the above-described embodiments is disposed within the housing 120.

For example, the liquid leakage detector 10 may be provided on a bottom surface (e.g., on a bottom plate) of the housing 120. The liquid leakage detector 10 based on the FFC 20 can be easily integrated and installed into the battery system 100. In various embodiments, the battery system 100 may include a battery pack and/or a battery module.

According to embodiments of the present disclosure, a liquid leakage detector 10 for detecting liquid in a battery system is provided that is easy to install and integrate and is very cost-efficient. Also, sensing robustness is improved and detection time increased as described above. Further aspects and features of the present disclosure are disclosed or can be derived from the above disclosure.

### DESCRIPTION OF SOME REFERENCE SYMBOL

10 liquid leakage detector 20 flexible flat cable (FFC)

22 first electrical conductor 23, 23’, 23’’ first exposed portion

24 second electrical conductor 25, 25’, 25’’ second exposed portion

26 insulating layer 27, 27’, 27’’ first opening

28, 28, 28’’ second opening P pair of exposed portions

P1, P2, P3 pairs of exposed portions E1 first end portion

E2 second end portion 30 electrical resistor

40 detection unit 50 water-soluble coating

60 ion releasing material 70 corrosion protection layer

D1 cable direction W width

H height 100 battery system

110 battery cell 120 housing

What is claimed is:

1. A liquid leakage detector for detecting liquid in a battery system, the liquid leakage detector comprising:
a flexible flat cable (FFC) comprising:
a first electrical conductor and a second electrical conductor extending parallel to each other;
an insulating layer partially enclosing at least one of the first electrical conductor and the second electrical conductor, the insulating layer having a first opening forming a first exposed portion at where the first electrical conductor is exposed through the insulating layer and a second opening forming a second exposed portion at where the second electrical conductor is exposed through the insulating layer;
an electrical resistor at a first end portion of the FFC and electrically connected with the first electrical conductor and the second electrical conductor; and
a detector electrically connected to the first electrical conductor and the second electrical conductor at a second end portion of the FFC opposite to the first end portion, the detector being configured to detect liquid by identifying an electrical current flowing via the liquid between the first exposed portion and the second exposed portion.

2. The liquid leakage detector as claimed in claim 1, wherein the FFC and/or the first and second electrical conductors has a rectangular cross-section having a width and a height, and
wherein the height is smaller than the width.

3. The liquid leakage detector as claimed in claim 1, further comprising a water-soluble coating covering the first exposed portion and the second exposed portion.

4. The liquid leakage detector as claimed in claim 3, wherein the water-soluble coating comprises a polyvinyl alcohol tape.

5. The liquid leakage detector as claimed in claim 3, further comprising an ion releasing material at the first and second openings,
wherein the ion releasing material is configured to release ions into the liquid when dissolved by the liquid.

6. The liquid leakage detector as claimed in claim 5, wherein the ion releasing material is between the water-soluble coating and the exposed portions, respectively.

7. The liquid leakage detector as claimed in claim 5, wherein the ion releasing material comprises a salt.

8. The liquid leakage detector as claimed in claim 5, wherein the ion releasing material is a coating and/or a powder.

9. The liquid leakage detector as claimed in claim 5, wherein the water-soluble coating comprises the ion releasing material.

10. The liquid leakage detector as claimed in claim 1, further comprising a corrosion protection layer directly on the first exposed portion and the second exposed portion.

11. The liquid leakage detector as claimed in claim 10, wherein the corrosion protection layer is a coating comprising at least one of gold, tin, and/or nickel.

12. The liquid leakage detector as claimed in claim 1, wherein the first and the second openings are spaced from each other in an extension direction of the FFC by a displacement difference.

13. The liquid leakage detector as claimed in claim 1, wherein the insulating layer has a plurality of openings exposing ones of the first and second electrical conductors, and
wherein the plurality of openings are formed in pairs along an extension direction of the FFC.

14. The liquid leakage detector as claimed in claim 1, wherein the electrical resistor has a resistance value in a range between 100kΩ and 300kΩ.

15. A battery system comprising:
a plurality of battery cells accommodated in a housing; and
a liquid leakage detector as claimed in claim 1 in the housing.
